(19) United States
(12) Patent Application Publication
(10) Pub. No.: US 2006/0143367 A1
(43) Pub. Date: Jun. 29, 2006

(54) Non-volatile memory lock

(76) Inventors: Scott P. Dubal, Hillsboro, OR (US); Miles J. Penner, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,958

(22) Filed: Dec. 27, 2004

(51) Int. Cl. G06F 12/00

(52) U.S. Cl. 711/103

(57) ABSTRACT

In some embodiments access to a non-volatile memory is controlled. If a received code matches an unlock code, write access to the non-volatile memory is allowed. If the received code does not match the unlock code, write access to the non-volatile memory is not allowed. Other embodiments are described and claimed.

### TECHNICAL FIELD

The inventions generally relate to a non-volatile memory lock.

### BACKGROUND

Current network adapter and LAN (Local Area Network) On Motherboard (LOM) designs allow unsecured access to a non-volatile memory resident on the network adapter or the LOM. The non-volatile memory typically used by a network adapter or a LAN On Motherboard (LOM) device in a non-volatile Random Access Memory (NVRAM). This unsecured access to the NVRAM can allow a user to change and/or spoof their MAC (Media Access Control) address, modify the ID of the device, or possibly even write a virus into the boot ROM (Read Only Memory) code of the network adapter or LOM device.

Similar concerns occur with respect to computer system motherboard designs that include non-volatile memory. Reprogramming the BIOS (Basic Input/Output System) on a computer motherboard can be implemented by finding a correct BIOS tool and/or image to reprogram the BIOS.

A need therefore exists for protecting non-volatile memory such as NVRAM in a computer system or a network device from malfeasant and malicious invaders, hackers, etc.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a non-volatile memory combination lock arrangement according to some embodiments of the inventions.

FIG. 2 illustrates a non-volatile memory combination lock arrangement according to some embodiments of the inventions.

### DETAILED DESCRIPTION

Some embodiments of the inventions relate to a non-volatile memory lock.

In some embodiments access to a non-volatile memory is controlled. If a received code matches an unlock code, write access to the non-volatile memory is allowed. If the received code does not match the unlock code, write access to the non-volatile memory is not allowed.

In some embodiments an apparatus includes a non-volatile memory to store an unlock code, and a controller to allow write access to the non-volatile memory if a received code matches the unlock code, and to not allow write access to the non-volatile memory if the received code does not match the unlock code.

Non-volatile memory (for example, NVRAM) of a network adapter or a LAN On Motherboard (LOM) device, for example, typically contains information such as boot ROM (Read Only Memory) code, firmware, a unique MAC (Media Access Control) address, device IDs, and special device specific settings needed to load a device driver or other special software on the network adapter or LOM device, for example. In some embodiments a user defined combination unlock code is stored in a new location in a non-volatile memory (for example, NVRAM). This combination unlock code cannot be read until the non-volatile memory is unlocked. Additionally, in some embodiments the non-volatile memory cannot be written to until the correct combination unlock code is specified.

In some embodiments a non-volatile memory device is allowed to be programmed when a specific code is provided to the non-volatile memory device and is not allowed to be programmed when the specific code is not provided to the non-volatile memory device.

In some embodiments a combinational lock mechanism or arrangement is implemented on non-volatile memory of a network adapter, a LAN On Motherboard (LOM) device, a BIOS (Basic Input/Output System) memory device (for example, included within a computer system such as a desktop or a server), and/or any other type, use, or location of a non-volatile memory to turn off and/or on read/write access to the non-volatile memory.

In some embodiments non-volatile memory is used that is non-volatile RAM (Random Access Memory), non-volatile ROM (Read Only Memory), reprogrammable ROM, flash memory, non-volatile RAM (NVRAM), Electrically Erasable Programmable Read Only Memory (EEPROM), flash ROM, BIOS, flash BIOS, computer motherboard BIOS, and/or any other type of non-volatile memory device.

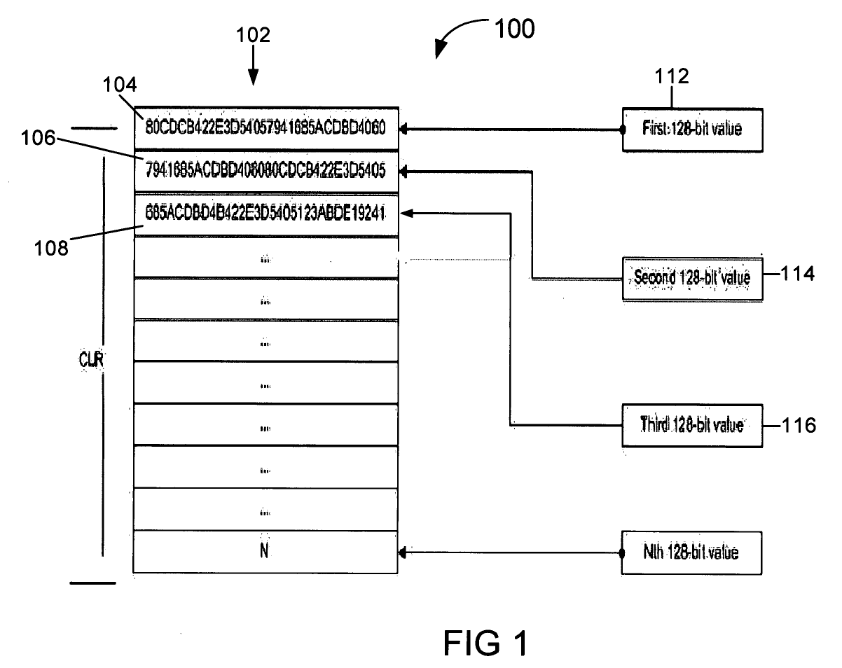

FIG. 1 illustrates a non-volatile memory combination lock arrangement 100 according to some embodiments. FIG. 1 includes a combination lock register (CLR) 102 that is a register in the silicon register set of a non-volatile memory. In some embodiments this combination register area (or CLR) is greater than or equal to 128 bits in length in order to create a sufficient combination space to deter “brute force” hacking attacks. In some embodiments CLR 102 includes three or more 128 bit register storage areas 104, 106, 108, etc. Exemplary required 128 bit values stored in registers 104, 106, and 108 are illustrated in FIG. 1 in hexadecimal format (32 hexadecimal characters is equivalent to 128 binary bits).

Although CLR 102 illustrated in FIG. 1 includes N 128 bit register storage areas that each store 128 bits any number of registers may be included in CLR 102 according to some embodiments, and each register storage area of CLR 102 may store a number of bits other than 128 bits according to some embodiments (for example, any number of bits greater than 128 in each storage area in some embodiments or 256 bits in each storage area in some embodiments).

In some embodiments in order to unlock the combination lock at least three successive 128 bit values must be entered into the combination lock region. For example, a first 128 bit value 112, a second 128 bit value 114, and then a third 128 bit value 116 must be entered to unlock the non-volatile memory.

Each bit is a position of the combination lock similar to a dial combination lock used on a locker. In some embodiments a computer program attempts to unlock the combination lock. A computer program that attempts to unlock the combination lock is required in some embodiments to write a minimum of three (or more) successive 128 bit values in to the combination lock region (CLR) 102 of the non-volatile memory in order to successfully be able to write to (or rewrite) the non-volatile memory. In some embodiments, by requiring more than three successive 128 bit values to be used in the combination lock mechanism, the combination lock is even more difficult to break.

In some embodiments a default combination is used in order for the customer to unlock the non-volatile memory. In some embodiments the default combination is a 128 bit value pre-stored in the combination lock register (CLR) 102. Once a customer unlocks the non-volatile memory using the default combination the combination may be changed to be set to a new user defined value when the non-volatile memory is put into use. In this manner, for example, an administrator of the device containing the non-volatile memory is able to define and set a combination in the CLR 102 to lock out intruders according to the administrator's own personal security preferences (for example, requiring one 128 bit number, three 128 bit numbers, N 128 bit numbers, three 256 bit numbers, etc.)

In some embodiments once a combination has been set in the CLR 102 any request to write to the non-volatile memory requires a process of unlocking the combination lock. This may be implemented in some embodiments as follows. For example, where the combination lock is set up to require three 128 bit values to be entered that match three 128 bit values required to be stored in CLR storage areas 104, 106, and 108, respectively. First the storage area 104 of the combination lock register 102 is written to with the first 128 bit required value, then the second storage area 106 of the CLR 102 is written to with the second 128 bit required value, and then the third storage area 108 of the CLR 102 is written to with the third 128 bit required value. If the combination unlock code is correct (that is, the three values written to the CLR 102 are the correct values) then the non-volatile memory may be written to using normal procedures defined by the non-volatile memory silicon. Otherwise, writes accesses to the non-volatile memory will fail.

In some embodiments an optional bit and/or a status register (SR) in the non-volatile memory and/or in the CLR indicates if the non-volatile memory is currently locked for writing. If such an optional bit and/or status register indicates that the non-volatile memory is currently locked for writing then the non-volatile memory can not be written to, even if the correct combination unlock code is transferred to the combination lock register. In some embodiments the non-volatile memory cannot be written to until the optional bit and/or status register is changed to indicate that the non-volatile memory is not currently locked, and the correct combination unlock code is provided to the combination lock register.

In some embodiments in which more than three values (for example, 128 bit values) must be provided in order to unlock the non-volatile memory then additional values are written to the CLR 102 until the correct number of values (for example, the Nth 128 bit value) are written to the CLR 102.

In some embodiments in order to change the non-volatile memory combination lock code, the non-volatile memory must first be unlocked by providing the correct current combination lock code. A system administrator may provide the combination lock code, for example. Then a new combination unlock code is written to the combination unlock code area (or combination lock register) of the non-volatile memory.

In some embodiments use of a required combination unlock code allows access to non-volatile memory (resident, for example, on a network adapter, a LOM device, a computer motherboard, etc.) only to programs, drivers, tools, etc. that know the combination (that is, the required combination unlock code). In some embodiments the combination unlock numbers can be changed by the system administrator to protect their system from malicious hackers, for example.

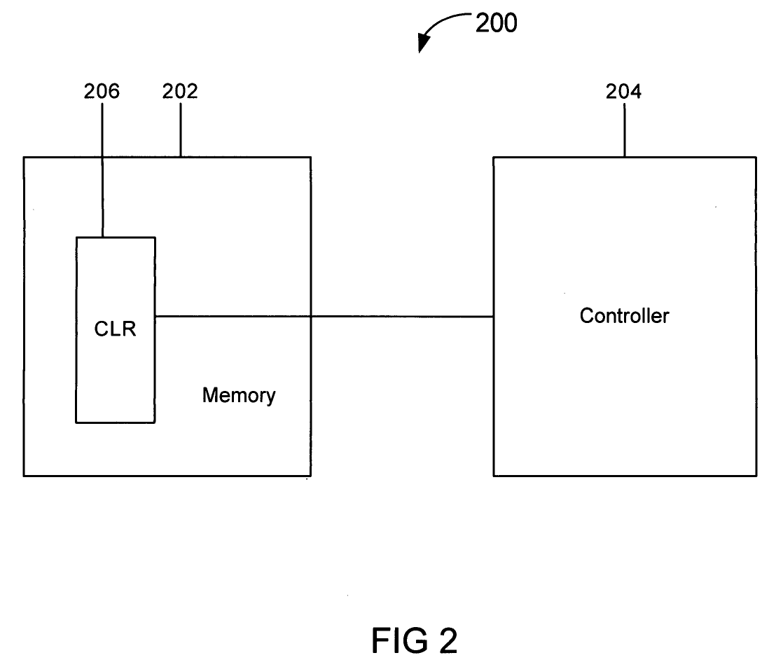

FIG. 2 illustrates a non-volatile memory combination lock arrangement 200 according to some embodiments. Arrangement 200 includes a non-volatile memory 202 and a controller 204 coupled to the non-volatile memory 202. Non-volatile memory 202 includes a combination lock register (CLR) 206 which may also be coupled to the controller 204. In some embodiments CLR 206 is a register in the silicon register set of non-volatile memory 202. In order to unlock non-volatile memory 202 (for example, in order to write to the non-volatile memory 202) a combination unlock code must be provided (for example, in some embodiments from the controller 206) to the non-volatile memory 202 (for example, in some embodiments to the CLR 206). Once the correct combination unlock code is provided to the non-volatile memory 202 (for example, to match with the correct combination unlock code stored in CLR 206) then the non-volatile memory may be written to (for example, by controller 204 and/or by a program, driver, or tool, for example). In some embodiments a correct combination unlock code stored in non-volatile memory (for example, in CLR 206) may be changed (for example, by an administrator of a system including the non-volatile memory 202, for example). In some embodiments in order to change a correct combination unlock code stored in the non-volatile memory 202 (for example, in CLR 206) the correct current combination unlock code stored therein must be specified, and then the new desired combination unlock code may be stored therein.

In some embodiments the controller 204 performs functionality to control write access to the non-volatile memory 202 in response to a specification of the correct unlock code. In some embodiments the controller 204 is external to the non-volatile memory 202. In some embodiments the controller 204 is internal to the non-volatile memory 202, where the internal controller is embedded into the interface to the non-volatile memory. In some embodiments controller 204 may be implemented in hardware, software, and/or firmware, and/or a combination thereof.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method of controlling access to a non-volatile memory comprising:
receiving a code;
if the received code matches an unlock code, allowing write access to the non-volatile memory; and
if the received code does not match the unlock code, not allowing write access to the non-volatile memory.

2. The method of claim 1, further comprising allowing the unlock code to be changed if the received code matches the unlock code.

3. The method of claim 1, wherein the unlock code includes at least three 128 bit values.

4. The method of claim 1, wherein at least one bit indicates whether the non-volatile memory is currently locked for writing, and not allowing write access to the non-volatile memory if the at least one bit indicates that the non-volatile memory is currently locked for writing, even if the specified code matches the unlock code.

5. The method of claim 1, wherein the unlock code is stored within the non-volatile memory.

6. An article comprising:
a computer readable medium having instructions thereon which when executed cause a computer to:
receive a code;
if the received code matches an unlock code, allow write access to the non-volatile memory; and
if the specified code does not match the unlock code, not allow write access to the non-volatile memory.

7. The article of claim 6, the computer readable medium further having instructions thereon which when executed cause a computer to allow the unlock code to be changed if the received code matches the unlock code.

8. The article of claim 6, wherein the unlock code includes at least three 128 bit values.

9. The article of claim 6, wherein at least one bit indicates whether the non-volatile memory is currently locked for writing, the computer readable medium further having instructions thereon which when executed cause a computer to not allow write access to the non-volatile memory if the at least one bit indicates that the non-volatile memory is currently locked for writing, even if the specified code matches the unlock code.

10. The article of claim 6, wherein the unlock code is stored within the non-volatile memory.

11. An apparatus comprising:
a non-volatile memory to store an unlock code; and
a controller to allow write access to the non-volatile memory if a received code matches the unlock code, and to not allow write access to the non-volatile memory if the received code does not match the unlock code.

12. The apparatus of claim 11, wherein the controller is to allow the unlock code to be changed if the received code matches the unlock code.

13. The apparatus of claim 11, wherein the unlock code includes at least three 128 bit values.

14. The apparatus of claim 11, further comprising at least one bit that indicates whether the non-volatile memory is currently locked for writing, the controller to not allow write access to the non-volatile memory if the at least one bit indicates that the non-volatile memory is currently locked for writing, even if the received code matches the unlock code.

15. The apparatus of claim 11, wherein the non-volatile memory includes a combination lock register to store the unlock code.

16. The apparatus of claim 11, wherein the controller is external to the non-volatile memory.
